(19) United States
(12) Patent Application Publication
(10) Pub. No.: US 2005/0065227 A1
(43) Pub. Date: Mar. 24, 2005

(54) Visible-light sensitive macro-initiator

(76) Inventor: John R. Condon, Portland, OR (US)

Correspondence Address: John R. Condon, 15571 Oatfield Rd., Portland, OR, 97267, US

(21) Appl. No.: 10/664,848

(22) Filed: Sep. 22, 2003

(51) Int. Cl. C08G 2/00

(52) U.S. Cl. 522/1

(57) ABSTRACT

Type II photoinitiators interact with co-initiating agents to initiate polymerization in ethylenically unsaturated resins when exposed to irradiation. In the current invention, said photoinitiators are bound to the surface or synthesized on the surface of polymer or inorganic particles or molecules, creating a complex which is multifunctional with respect to the photo-initiating capability. The mixture of said photoinitiator in said monomer/co-initiator mixture will demonstrate a low level of elution of initiator species from the cured polymer in liquid media.

### FEDERAL SPONSORSHIP

This invention was the result of research that was funded by an SBIR grant provided by the National Institutes of Health/National Institute of Dental and Craniofacial Research.

### BACKGROUND

1. Field of the Invention

The invention pertains to the addition polymerization of organic resins through free radical polymerization. The addition to said resins of initiating agents that create free radicals in response to electromagnetic irradiation has been described in U.S. Pat. No. 4,529,491. Visible light photoinitiators are sensitive to irradiation in the region 450-610 nm. The invention is comprised of two or more Type II photoinitiator molecules that are covalently bound to a substrate molecule or a granule of powder, forming a complex that is multifunctional with respect to the Type II photo-initiating capability. The invention also includes mixtures of said multifunctional photoinitiators, also called macroinitiators, in ethylenically unsaturated monomer, especially mixtures intended for use as dental restoratives or adhesives.

2. Prior Art

Macroinitiator for cathodic polymerization was described in U.S. Pat. No. 4,677,137. Initiating species were dried onto the surface of fine particles. No covalent bonding was achieved, leaving the initiators susceptible to easy dissociation from the carrier particles. The invention aided in dispersing the photoinitiator species into monomer systems in which it was not soluble. Therefore, dissociation from the carrier particles was not a concern. However, the visible light sensitive anodic initiators are soluble in ethylenically unsaturated monomers, therefore covalent bonding is necessary between the initiator molecules and the substrate in order in prevent dissociation in the mixture.

Type I anodic photoinitiator that is covalently bonded to an inert substrate has been described in U.S. Pat. No. 6,296,986. Likewise, surfaces treated with Type I photo-initiator for the purpose of generating photo-polymerized coatings were described in EP1072326. However, Type I photoinitiators respond to irradiation by forming free radicals, which act directly upon the monomer to initiate polymerization. Type I photoinitiators are exclusively sensitive to ultraviolet light. The current invention describes Type II photoinitiators, which responds to irradiation by interacting with a co-initiator. Said co-initiator forms a free-radical which interacts with the monomer molecules to initiate polymerization. Visible-light sensitive photo-initiators belong exclusively to the Type II class. Ultra-violet exposure is not compatible with health-care related applications such as the placement of dental adhesives and restoratives. Visible-light activation is typically used in this field. Dental restoratives and adhesives typically contain camphorquinone, which is a Type II photoinitiator. No examples of Type II photoinitiators covalently bonded or synthesized on the surface of substrate particles or molecules exist in the prior art.

Methacrylate-containing monomers can be polymerized through anionic, free-radical polymerization. This reaction can be initiated through free radical generators, such as the reduction/oxidation reaction of certain compounds. Other compounds can be photo-ionized to act as free radical generators. Often ultraviolet light is used to excite photo-initiating species. Macroinitiators that are sensitive to ultraviolet irradiation have been developed. They offer more homogenous block polymerization. In dentistry, restorative materials and adhesives have a resin component that is photo-cured during clinical application. In this setting, ultraviolet light is not desirable because of its mutagenic capability. Instead, visible light photo-initiation is used for the application of resin sealants and cements, and resin composite restoratives and resin-modified glass ionomers. Recently, a mixture containing photo-initiator that responds to green to infrared light was developed (Pat #WO0159521).

### OBJECTS AND ADVANTAGES

For dental applications, photosensitizers such as camphorquinone or fluorenone are added to a co-monomer mixture along with a tertiary amine co-initiator. Some concern about the cytotoxic effect of eluted photoinitiators has been expressed. Their bright yellow color can interfere with the esthetic qualities of the admixed formulation. By anchoring the photo-initiating species to an inert substrate, their ability to diffuse out of the cured mass will be reduced. Also their optical effect on the mixture may be reduced. As well, by concentrating the photoinitiator at sites within the resin, the dynamics of the polymerization may be altered. High stress levels result from the polymerization of resin composites in confined, adhesively coupled settings. The altered dynamics of the polymerization of resin composites that contain macroinitiators may lead to a reduction in internal stress levels.

### SUMMARY

The present invention provides a Type II multifunctional photoinitiator that is obtainable as the reaction product of a multifunctional core material containing two or more reactive groups and a photoinitiator or a precursor or a derivative thereof, which photoinitiator or its precursor or derivative has a reactive group capable of reacting with said reactive groups of the multifunctional core.

### DETAILED DESCRIPTION

The Type II multifunctional photoinitiators of the present invention may have a large range of sizes. These sizes would include the range from the 100 micron particle size present in coarsely-filled commercial composite dental restoratives through the sub-micron particle size of the so-called “mini-filled” composites. Preferably, the size of the multifunctional photoinitiators would be closer to that of the fumed silica that is used in so-called “nano-filled” composites, which are in the range of 40 nm in average size. A very fine dispersion of the multifunctional photoinitiators in the resin such as that provided by the fumed silica particles is preferable because the presence of large expanses of resin between initiator molecules can lead to a low final level of polymerization. A ceramic particle is preferable as a substrate for the multifunctional photoinitiators in dental applications because of the increased wear resistance and stiffness that hard ceramic particles impart to the mixture. However, embodiments of the current invention include Type II multifunctional photoinitiators based upon polymeric substrates and multifunctional molecules. Polymeric beads can have reactive sites that form covalent bonds with the reactive sites on the photoinitiator molecules or photoinitiator precursor molecules. Their sizes range from single molecules having as few as two reactive sites to beads formed of long chain polymers or cross-linked polymers which have a size up to 100 microns and a high number of reactive sites.

A preferred embodiment of the mixture contains acrylate- or methacrylate-functional resins, having either single, double or a higher number or functional terminations or a co-monomer containing said monomers, but not excluding mixtures which contain resins of other ethylenically unsaturated moieties. The mixture will also contain visible-light sensitive multifunctional photo-initiating particles or molecules, though it may also contain mono-functional photoinitiators that respond to visible light to further promote polymerization. The mixtures in the preferred embodiment include, but are not limited to, mixtures that also contain a co-initiator, typically being, but not limited to, a tertiary amine such as dimethylaminoethyl methacrylate or cyanoethylmethyl aniline.

Another embodiment of the invention involves resin modified glass ionomers. Type II macroinitiators can be added in the place of or in addition to freely-mixed photoinitiator in a typical resin-modified glass ionomers, containing the hybrid monomer, glass fillers and a co-initiator, as well as other additives.

An advantage of the current invention is the reduced extraction of multifunctional photoinitiators over known mono-functional photoinitiators. Although not wishing to be bound by any particular theory or explanation, the applicants have conjectured that this phenomenon is a consequence of the reduced molecular mobility of the multifunctional monomer due to its increased size.

Multifunctional photoinitiators according to the present invention not only show good photo-initiating properties but, in addition, possess one or more advantages over the co-polymerizable photoinitiators described in U.S. Pat. No. 4,922,004. For example, compared to the ethylenically unsaturated materials, or indeed compared with any mono-functional material they result in cured compositions having higher molecular weights and increased hardness. This is attributable to their poly-functional nature.

Compared with mixtures containing mono-functional visible-light photoinitiators, the mixtures containing multi-functional photoinitiators may have a color that is less affected by the presence of the photo-initiating species. Most visible light sensitive photoinitiators possess a pronounced yellow color, and said photoinitiators impart this color to resin mixtures in a way that interferes with their usage as an esthetic dental restorative material. Covalently bonding the photo-initiating molecule to a substrate may alter the optical quality of the photoinitiator molecules and may produce mixtures in monomeric resins that are less profoundly affected by the color of the photoinitiator molecule.

Mixtures containing visible light sensitive multifunctional photoinitiators may produce lower levels of tensile stress when they are polymerized in a confined setting when compared to mixtures containing visible light sensitive mono-functional photoinitiators. While not desiring to be bound to a single explanation, the inventor believes that the propagation of polymerization from concentrated sites within the resin prolongs the period during which the resin remains a liquid, allowing polymerization shrinkage to be transmitted to the free surfaces of the polymer mixture. Further, the early increments of shrinkage may take place while the resin matrix has developed a lower modulus of elasticity in the mixtures containing multifunctional photoinitiators as compared to the mixtures containing mono-functional photoinitiators, leading to lower levels of final polymerization stresses.

The preparation of Type II multi-functional photoinitiator can be done by, but is not limited to, synthesizing the photo-initiating molecules on the surface of a reactive substrate, or by reacting a photo-initiating compound that has a reactive site with the complementary reactive sites on the surface of the carrier particle of molecule. Some commercially available photoinitiators have a reactive group capable of reacting with suitable reactive groups on a multifunctional core material. Fluorenone carboxylic acid is available with the acid moiety in the #1 and #4 position. Some photoinitiator precursors are commercially available having a suitable reactive site. Bromocamphor 10-sulfonic acid can be bound to the surface of a suitably treated substrate and subsequently oxidized to camphorquinone, having a linkage to the substrate in the #10 position.

It should be appreciated that a very wide range of mutually reactive groups are available for use as the respective reactive groups of the multifunctional core material and the photoinitiator or its derivative. For example, when one of these is an acid or acid anhydride group, the other may be selected from hydroxy groups, amine groups, epoxy groups and isocyanate groups.

Alternatively, when one is an acrylate or methacrylate group, the other may for example be selected from amine groups and thiol groups.

Yet again, if one is an amine group the other may be selected from acid groups, acid anhydride groups, acrylate groups, isocyanate groups and epoxy groups.

In the case of one of the aforementioned groups being a hydroxy group, the other may be selected from carbonyl derivatives, isocyanates, acids or acid anhydrides, acid halides and esters.

### EXAMPLE #1

Preparation of Multifunctional Photo-Initiator:

Fumed silica (average size=40 nm) was treated by adding 5 grams to a solution of 3 mL of aminopropyl trimethoxysilane in 50 mL of 95% isopropyl alcohol, buffered to 5.0 pH with acetic acid. After stirring 20 minutes, the silica was separated by centrifugation and rinsed with 50 mL of DCM 3 times.

Ketopinic acid (1 gram) was dissolved in acetic acid (100 mL) with 5 mL water. A stochiometric abundance (1.5 grams=200%) of selenium dioxide was added to the solution and stirred for 24 hours at room temperature. The solvent was driven off with low heat, and the camphorquinone carboxylic acid was extracted with DCM (50 mL). 1,1-dichloromethylmethyl ether (1.0 grams) was added and stirred for 5 minutes. Amino-silanated silica (3 grams) was added to the solution with 1 mL 5M NaOH and stirred for 10 min. Treated silica was separated from the solution using centrifugation and rinsed with 50 mL of DCM 3 times. The particles were dried in 80° C. air.

Preparation of Visible-Light Sensitive Resin Mixture:

Multifunctional photo-initiator (1 gram) was added to diurethane dimethacrylate resin (10 g). Dimethyl aminoethyl methacrylate (DMAEMA, 0.1 grams) was added as a co-initiator. After exposure to bright blue light for 40 seconds, thin films of the resin were evaluated using infrared spectroscopy. A conversion level of 75% was observed, indicating a significant level of polymerization.

A test of the polymerization stress was performed on this compound and compared with a control material that contained 1 wt % free camphorquinone in the place of the multifunctional photoinitiator. After 60 sec of light-curing between 6 mm diameter acrylic rods in a tensilometer, the resin containing multifunctional photoinitiator generated 31N of force, while the control material produced 62N of force (n=5).

### EXAMPLE #2

Preparation of Multifunctional Photo-Initiator:

Fluorenone 4-carboxylic acid (0.1 gram) was added to pyridine (50 mL). Phosphorous pentachloride (0.1 gram) was added to the solution. Polyethyleneimide (MW=25,000) was dissolved in pyridine (50 mL). The two solutions were mixed together, resulting in an abundance of yellow precipitant. Solvent was decanted and the precipitant was rinsed with acetone (100 mL three times) and dried.

Preparation of Visible-Light Sensitive Resin Mixture:

Multifunctional photo-initiator (0.1 gram) was added to diurethane dimethacrylate resin (3 g). Dimethyl aminoethyl methacrylate (DMAEMA, 0.03 grams) was added as a co-initiator. After exposure to bright blue light for 40 seconds, thin films of the resin had hardened, indicating a significant level of polymerization had occurred.

### EXAMPLE #3

Preparation of Multifunctional Photo-Initiator:

Bromo-camphor sulfonic acid, ammonium salt (0.5 grams) was dissolved in acetone (30 mL) and treated with sulfuric acid (0.2 grams). Solvent was decanted and treated with 1,1-dichloromethylmethyl ether (0.1 grams) to make the sulfonyl chloride.

Amino-functional fumed silica (1 gram) was treated as in example #1 and suspended in dimethyl formamide (10 mL). The prepared solution of bromo-camphor sulfonyl chloride was added to the suspension of treated particles and stirred with sodium iodide (0.1 gram) for 10 minutes. The particles were separated from the solution by centrifugation and rinsed in DMSO (20 mL, 3 times).

The suspension of bromo-camphor-treated particles in DMSO was placed in a sparger, through which oxygen was bubbled while heating to 120° C. for two hours. Particles were separated from solution through centrifugation and rinsed with DMSO (20 mL, 3 times) and isopropanol (20 mL, 3 times) and dried in 80° C. air.

Preparation of Visible-Light Sensitive Resin Mixture:

Multifunctional photo-initiator (1 gram) was added to diurethane dimethacrylate resin (10 g). Dimethyl aminoethyl methacrylate (DMAEMA, 0.1 grams) was added as a co-initiator. After exposure to bright blue light for 40 seconds, thin films of the resin had hardened, indicating a significant level of polymerization had occurred.

1. An initiator of anodic free-radical polymerization that is sensitized to visible light irradiation and provides multiple initiator functionality sites on each molecule or molecular complex.

2. The initiator in claim 1 in which the substrate of the molecular complex is a ceramic particle.

3. The initiator in claim 1 in which the substrate is a polymeric particle.

4. The initiator in claim 1 in which the substrate is a macromolecule.

5. Mixtures of said multi-functional photo-initiator in ethylenically unsaturated organic monomer.
